(19) United States
(12) Patent Application Publication
(10) Pub. No.: US 2005/0193133 A1
(43) Pub. Date: Sep. 1, 2005

(54) Message header for messaging service

(75) Inventors: Aki Niemi, Helsinki (FI); Juha Kalliokulju, Vesilahti (FI); Satu Kalliokulju, Vesilahti (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION, Espoo (FI)

(21) Appl. No.: 10/510,042

(22) PCT Filed: Mar. 26, 2003
(86) PCT No.: PCT/IB03/01411

§ 371 Date: Nov. 9, 2004

(30) Foreign Application Priority Data
Apr. 8, 2002 (GB) 0208069.5

(51) Int. Cl. G06F 15/16

(52) U.S. Cl. 709/230; 709/218

(57) ABSTRACT

There is provided a mobile communications system in which at least a first and second type of message service are supported, wherein the system includes first and second application servers associated with the at least the first and second message service types, wherein the first and second types of message service are transported by an SIP message to the first application server, each SIP message including a control portion identifying the type of message, wherein the first application server is adapted to direct messages of the second type to the second application server.

### FIELD OF THE INVENTION

The present invention relates to network environments supporting multiple messaging services, and particularly but not exclusively to such environments in which different messaging services have different requirements.

### BACKGROUND TO THE INVENTION

Messaging services are well known in the field of wireless mobile telecommunications. A short message service (SMS) enables simple messages to be sent between mobile terminals, such as mobile telephones, in a wireless communication system. The extended message service (EMS) is an evolution of SMS, and allows enhanced messages, for example including formatted text, to be transmitted between mobile terminals. SMS and EMS services are supported in mobile communication systems such as GSM.

More recently, in wireless mobile communications, there has been developed a multimedia message service (MMS) that can transport pictures and video clips, for example, between mobile terminals. MMS services are supported in third generation mobile communication systems, such as GPRS and UMTS.

Other types of messaging services are also known in other areas of communication, one example being that of instant messaging (IM). In instant messaging an instant communication session, or chat session, is established between two users of a communication system, typically via computer terminals using computer networks.

The SMS, EMS and MMS messaging services have all been standardised in third generation mobile communications in the ETSI/3GPP forum.

To date, no instant messaging services have been standardised within ETSI/3GPP, but there is a desire to introduce instant messaging services in wireless mobile communication systems.

However, the requirements of SMS and MMS messaging are different to those of instant messaging. In SMS and MMS messaging there is a requirements for reliable delivery, i.e. for a message to be delivered to the recipient. In IM messaging, there is a requirement for instant delivery, i.e. for the message to be delivered to the recipient instantly. As such the requirements of SMS/MMS messaging and IM messaging are different and not immediately compatible.

Furthermore, in introducing instant messaging services into the standardised environment of SMS/MMS, it is desirable for the architecture of the environment to remain unchanged such that the existing standardisation is unaffected.

In current work there have been proposals to introduce instant messaging services within the ETSI/3GPP standardisation by keeping the MMS architecture similar to the existing standardised MMS architecture, but replacing the WAP push mechanism used with an SIP NOTIFY mechanism. The SIP NOTIFY mechanism is standardized in the IETF.

However current work has also assumed that a different architecture is used for the instant messaging service. These solutions require that users have different addresses depending on which type of messaging is used. However it is highly desirable that users should have only a single address, independent of the application (i.e. messaging type) used.

The invention proposes a solution for supporting SMS/MMS messaging in the same mobile communication environment that overcomes one or all of the above stated problems.

### SUMMARY OF THE INVENTION

According to the present invention there is provided a method of supporting at least two types of message service in a mobile communications system, wherein the at least two types of message service are transported by a SIP message, a control portion of each SIP message including an identification of the type of message service.

The transmitted message is preferably processed in dependence on the identification in the control portion. The control portion may be a header of the SIP message. The control portion may be a value field of the SIP message.

All messages are preferably processed by an application associated with the second message type. For messages of the first type, the application associated with the second message type forwards the message to an application associated with messages of the second type.

The at least two types of messaging service preferably include a first type of messaging service dependent upon reliable delivery and a second type of messaging service dependent upon instant delivery.

Preferably the first type of messaging service is one of a: short message service; an extended message service; or a multimedia message service.

Preferably the second type of message service is an instant messaging service.

In another aspect the present invention provides a mobile communications system in which at least a first and second type of message service are supported, wherein the system includes first and second application servers associated with the at least the first and second message service types, wherein the first and second types of message service are transported by an SIP message to the first application server, each SIP message including a control portion identifying the type of message, wherein the first application server is adapted to direct messages of the second type to the second application server.

The first application server is preferably an Internet multimedia subsystem application server.

The second application server is preferably a multimedia message service application server.

The Internet multimedia subsystem application server is preferably adapted to store and forward SIP messages in dependence on the control portion identifying the message type.

The invention still further provides an application server of a mobile communications system in which at least a first and second type of message service are supported and in which the application server is associated with the first of said message types, wherein the first and second types of message service are transported by an SIP message to the application server, each SIP message including a control portion identifying the type of message, and wherein the application server is adapted to direct messages of the second type to a further application server.

The invention utilises an enhancement to the SIP MESSAGE, which is a method in the SIP protocol, not a header. This enables the utilisation of a single technology for multiple messaging services.

The invention preferably provides a new SIP header or value field to be able to utilise a single technology for different types of messaging services. Currently, ETSI/3GPP has standardised SMS and MMS (and EMS in the process), in accordance with the present invention the standardisation of instant messaging services within ETSI/3GPP is possible.

In the standardisation of instant messaging work it is highly probable that instant messaging, chat and MMS enhancements will be standardised.

The invention provides the necessary requirements from the user perspective to support the messaging, namely: a single recipient address and the possibility to select between ‘reliable delivery’ (e.g. SMS, MMS) and ‘instant delivery’ (e.g. IM). This invention provides a mechanism for such messaging features, which can be achieved with a single technology.

The present invention provides a number of advantages.

A single architecture is provided as a platform for different messaging types.

A single technology is provided as a platform for different messaging types.

A single addressing scheme is provided for different communication types (messaging, presence, voice, gaming).

The invention enables IMS to be more tightly integrated to all types of messaging.

Only one single infrastructure is needed to support two types of communications: bulk (like MMS, email) and real-time time (IM, voice, gaming), which messages have different characteristics.

### BRIEF DESCRIPTION OF THE DRAWINGS

The invention will now be described by way of example with reference to the accompanying drawings, in which:

FIG. 1 illustrates a proposed implementation of multimedia messaging services in a mobile wireless communication system;

FIG. 2 illustrates a proposed implementation of instant messaging services in a mobile wireless communication system; and

FIG. 3 illustrates a proposed implementation of multimedia messaging services and instant messaging services in a mobile wireless communication system implemented in accordance with the present invention.

### DESCRIPTION OF PREFERRED EMBODIMENTS

The invention is particularly described herein, with reference to an exemplary embodiment, with reference to a first type of messaging service exemplified by multimedia messaging service (MMS) and a second type of messaging service exemplified by instant messaging (IM).

MMS and IM are discussed herein as they are good examples of the different messaging paradigms, and as such provide a good illustration of the implementation of the present invention. However, as will be appreciated by one skilled in the art from reading the following description, the present invention is not limited in its applicability to such a scenario.

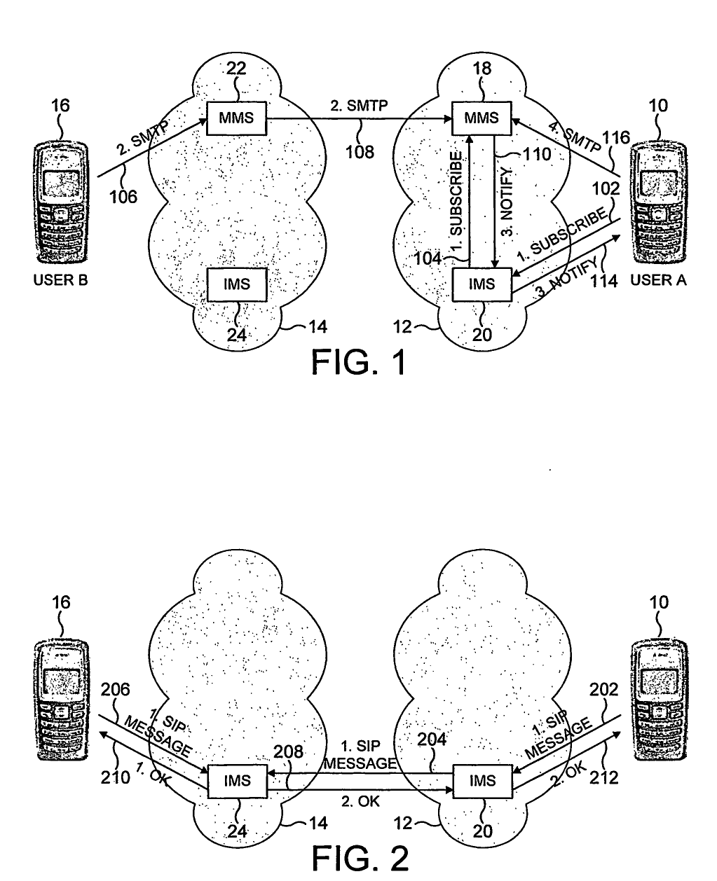

In each of FIGS. 1 to 3, there is illustrated a first mobile user terminal 10 connected in, or connectable to, a first mobile network 12. There is also illustrated a second user terminal 16 connected in, or connectable to, a second mobile network 14. The mobile user terminal 10 is associated with a first user, ‘user A’, and the mobile user terminal 16 is associated with a second user, ‘user B’.

Each of the first and second mobile networks includes a multimedia messaging service (MMS) application server and an Internet multimedia subsystem (IMS) Application server. The first mobile network 12 includes an MMS application server 18 and an IMS application server 20. The second mobile network includes an MMS application server 22 and an IMS application server 24.

Referring to FIG. 1, there is first illustrated the current assumption of the multimedia messaging service (MMS).

The user A subscribes for the MMS service by sending a subscribe request 102 to the IMS application server 20.

Responsive thereto the IMS application sends a subscribe request 104 to the MMS application 18.

The MMS subscribe request goes via the IMS application, and not direct to the MMS application itself, because the server accepting the subscription is within the IMS domain. That is, a request destined to “sip:nokia.com”, is sent to a nokia.com proxy (x-CSCF), which will then either process the request itself, or forward it to the designated MMS application server, e.g., “sip:mms-123.1 ms.nokia.com”. The request cannot be addressed directly to “sip:mms-123.1 ms.nokia.com”, because it might be allocated dynamically. Only the “home proxy” has intricate knowledge of the domain's topology. Such network interconnection is known in the art.

The user B, which provides the MMS content requested by the user A, sends an SMTP (simple mail transport protocol) message 106 to the MMS application server 106. The MMS application server 22 thereafter makes a HTTP post 108 to the MMS application 18. The trigger to send this MMS in the first place is totally internal to the user sending the message. It is addressed to MMS server 18, and that is why it gets routed there.

The MMS application 18 then sends a notify message 110 to the IMS application 20, which in turn forwards a notify message 114 to the user terminal 10. The notify message notifies the user terminal that the MMS message content has been posted to the MMS application server 18. Thereafter the user terminal sends a SMTP message 116 to the MMS application server in order to retrieve the MMS content.

Referring to FIG. 2, there is illustrated the current assumption of the instant messaging service. In FIG. 2, the user terminal 10 initiates an instant messaging session by transmitting an SIP message 202 to the IMS application server 20. The user terminal 16 also transmits an SIP message 206 to the IMS application server 24 to initiate an instant messaging session.

The message in FIG. 2 is sent via the home IMS simply because of accounting/architectural requirements of the 3GPP IMS.

In the example illustrated in FIG. 2, it is assumed that the mobile terminal 10 initiates the instant messaging session first. As such, an SIP message 204 associated with the terminal 202 is forwarded by the IMS application server 20 to the IMS application server 24. On receipt of the SIP message 204, and the receipt of the SIP message 206, the IMS application server 24 identifies that both parties requesting an instant messaging session are available, and transmits an OK message 208 to the IMS application server 20 and an OK message 210 to the user terminal 16. The IMS application server 20 forwards an OK message 212 to the user terminal 10. As such, an instant messaging session is established between the two users.

From the above descriptions of FIGS. 1 and 2, it can be seen that the current assumption of instant messaging uses SIP messages and only the IMS application servers associated with each user. The current assumption of multimedia message services uses the MMS application and the IMS application server of the user initiating the messaging service, and also proposes the use of SIP messages.

The current assumption of the instant messaging service in ETSI/3GPP is that it will be built on top of the SIP message. In brief, as shown hereinabove with reference to FIG. 2, the SIP message can be sent directly from a user A to a user B when an IM type service is being served, and as can be seen from FIG. 2 this messaging is efficient. In such a scenario as FIG. 2 the user B, associated with terminal 16, need only have one IM address to which the message can be sent.

However, referring to the implementation of MMS shown in FIG. 1, in order to have a single architecture/transport for different messaging scenarios (that would be feasible from the implementation perspective), the SIP message for the IMS arrangement of FIG. 2 should be routed to the MMS application of the user B.

However the format of the SIP header is such that the IMS application would be able to route either none of the SIP messages to the MMS application, or all of the SIP messages to the MMS application. However, neither of these solutions apply to both messaging cases; as can be seen from FIG. 1 all MMS messages need to be routed to the MMS application, whereas from FIG. 2 it can be seen that all IMS messages need not be routed to the MMS application.

A solution to achieve the MMS service in the IM service environment shown in FIG. 2 is to provide a separate address for a subscriber for MMS traffic. However this solution is not acceptable from the usability perspective, since it would require the user to have two addresses.

A further solution would be for the user terminal to set some headers of the SIP message to force its routing via the MMS application for MMS messages. However, the problem with this solution is that the user would need to configure a setting related to the message routing, and that is also unfeasible from a usability perspective.

The present invention therefore provides a solution to support different types of messaging service, and specifically an instant messaging service and a multimedia messaging service in a mobile communications network, which does provide for a single architecture for transporting both types of messages without effecting the usability of the services.

In accordance with the present invention, a new header(s) and/or new value(s) are defined in the SIP message, which is used to indicate the type of message service. In dependence on the type of message service identified, the message is routed to the appropriate one of the MMS application or the IMS application.

The IETF working group on the SIP change process have proposed “P”-headers, where P stands for preliminary, private or proprietary, and which headers may be used for introducing additional functionality in the SIP messages which does not affect the fundamental operation of the SIP messages. Thus there are reserved certain headers, termed P-headers, for further use. The use of the P-headers is particularly for features which require the use of a header but which are not considered to justify modification of the existing headers.

Thus, if the modification of the standardised SIP message headers to incorporate an identity of the type of message was not justified, the P-header could instead be used. The P headers take the format of P-XXXX.

In the presently described embodiment of the invention, it is required to distinguish between two different types of message service type. As such, the presence or absence of a particular P-header could simply be used to indicate the type of message. The P-XXXX header may then be created for the SIP message in dependence on the application from which the message is created. That is, if the MMS application is used to create the message the P-header is set, and if the IM application is used to create the message the P-header is not set. Furthermore, this header can also be utilised in the receiving terminal to identify whether the message is intended for an IMS or MMS application.

The IMS server 20 is thus adapted to support store and forward functionality.

The invention is not limited in its implementation to such use of P-headers in the SIP message. Another possible implementation is to utilise the Request-URI header of an SIP message as described below:

MESSAGEsip:joe.johnh@snokia.com;store-and-forward=yes SIP/2.0

Based on the store-and-forward information in the IMS application, the IMS application can direct the message to the MMS application server as appropriate. This is an adaptation of the request-line of a SIP message, namely the Request-URI. As such, it is not a header. The message contains:

[METHOD] destination [protocol] (the request-line) one-or-more headers:

A further possible implementation of the present invention is to utilise the ‘expires’ field in the SIP message. If the expiration time is set to ≠0, the IMS application studies the header field value, and if it equals to 0 the message is routed directly to the recipient, otherwise to the MMS application. However a problem with this solution is that if the expiry time has a useful meaning to the IM application, e.g. expired messages are ‘grayed’, this functionality can not be achieved as all such messages would be routed to the MMS application.

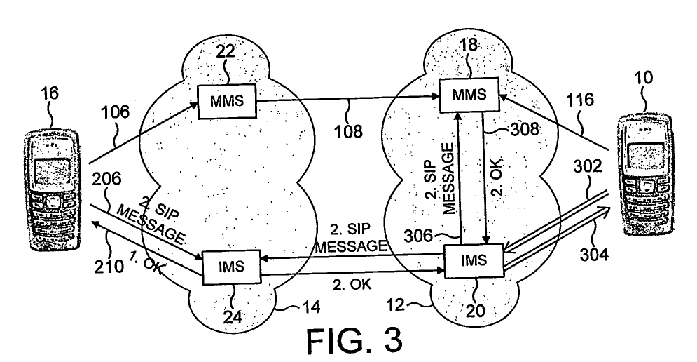

The implementation of the present invention is further illustrated with reference to FIG. 3. FIG. 3 shows the message flow for both IMS and MMS. For an IMS message, the operation is effectively as is shown in FIG. 2. The SIP message 302 corresponds to the SIP message 202, and the OK message 304 corresponds to the OK message 212. The IMS application 20 determines the appropriate routing of the SIP message to the IMS application 24 in accordance with the SIP header information as discussed hereinabove.

For an MMS operation, the user terminal similarly transmits an SIP message 302 to the IMS application 20. The IMS application determines an MMS message from the header information, and forwards the SIP message to the MMS application as message 306. Thereafter the HTTP post is made, and the MMS application returns an OK message 308 to the IMS application, and the IMS application then returns an OK message 304 to the mobile terminal 10. The mobile terminal can then retrieve the HTTP post as before.

Thus, in the embodiment of FIG. 3, the SIP messages 302 and 306 effectively replace the subscribe messages 102 and 104 of FIG. 1, and the SIP OK messages 308 and 304 effectively replace the Notify messages 110 and 114 of FIG. 1.

The present invention is not limited in its applicability or scope to any of the described embodiments. Although the invention is described in relation to an example of an MMS and an IM, it is not limited to those specific types. More generally the invention relates to any at least two types of message that are require to be handled differently in a single architecture.

Similarly the invention is not limited to using an IMS application server or an MMS application server. The invention may be utilised with any application server related to specific messaging types.

1. A method of supporting at least two types of message service in a mobile communications system, wherein the at least two types of message service are transported by a SIP message, a control portion of each SIP message including an identification of the type of message service.

2. A method according to claim 1 wherein a transmitted message is processed in dependence on the identification in the control portion.

3. A method according to claim 1 wherein the control portion is a header of the SIP message.

4. A method according to claim 1 wherein the control portion is a value field of the SIP message.

5. A method according to claim 1 wherein all messages are processed by an application associated with the second message type.

6. A method according to claim 5 wherein for messages of the first type, the application associated with the second message type forwards the message to an application associated with messages of the second type.

7. A method according to claim 1 wherein the at least two types of messaging service include a first type of messaging service dependent upon reliable delivery and a second type of messaging service dependent upon instant delivery.

8. A method according to claim 7 wherein the first type of messaging service is one of a: short message service; an extended message service; or a multimedia message service.

9. A method according to claim 7 wherein the second type of message service is an instant messaging service.

10. A mobile communications system in which at least a first and second type of message service are supported, wherein the system includes first and second application servers associated with the at least the first and second message service types, wherein the first and second types of message service are transported by an SIP message to the first application server, each SIP message including a control portion identifying the type of message, wherein the first application server is adapted to direct messages of the second type to the second application server.

11. A mobile communication system according to claim 10, wherein the control portion of the SIP message is a header field.

12. A mobile communication system according to claim 10, wherein the control portion of the SIP message is a value field.

13. A mobile communication system according claim 10, wherein the first type of message service is dependent upon the instant delivery of a message.

14. A mobile communication system according to claim 10, wherein the first type of message service is an instant messaging service.

15. A mobile communication system according to claim 13, wherein the first application server is an Internet multimedia subsystem application server.

16. A mobile communication server according to claim 10, wherein the second type of messaging service is dependent upon reliable delivery of a message.

17. A mobile communication system according to claim 10 wherein the second type of message service is one of either: a short message service; an extended message service; or a multimedia message service.

18. A mobile communication system according to claim 10 wherein the second application server is a multimedia message server application server.

19. A mobile communication system according to any one claim 15, wherein the Internet multimedia subsystem application server is adapted to store and forward SIP messages in dependence on the control portion identifying the message type.

20. An application server of a mobile communications system in which at least a first and second type of message service are supported and in which the application server is associated with the first of said message types, wherein the first and second types of message service are transported by an SIP message to the application server, each SIP message including a control portion identifying the type of message, and wherein the application server is adapted to direct messages of the second type to a further application server.

21. An application server according to claim 20 consisting of an Internet multimedia subsystem application server.

22. An application server according to claim 20, wherein the further server is a multimedia messaging service applications server.
